(19) United States
(12) Patent Application Publication
(10) Pub. No.: US 2008/0013712 A1
(43) Pub. Date: Jan. 17, 2008

(54) Unified Communication Directory Service

(76) Inventor: Karsten Gopinath, Mar Vista, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/776,030

(22) Filed: Jul. 11, 2007

Related U.S. Application Data
(60) Provisional application No. 60/830,406, filed on Jul. 11, 2006.

(51) Int. Cl. H04M 3/42

(52) U.S. Cl. 379/218.01

(57) ABSTRACT

A Universal Directory Service (UDS) stores all of a person's various communication service identifiers (i.e., home phone number, email address, cell phone number, etc.). The UDS enables a person to easily distribute any or all of his/her identifiers to others by simply distributing only one of the person's IDs. The UDS allows a person to easily find another person's communication service IDs, provided that the first person has at least one of the other person's IDs and has been granted appropriate access by the other person. A Universal Connection System (UCS) enables one person to connect to another person via any communication service by using one Universal ID (UID). The UCS enables one communication service to connect to a different communication service, even if different service providers operate these services.

### CROSS-REFERENCE TO RELATED APPLICATION

This application claims priority of provisional application 60/830,406, filed Jul. 11, 2006.

### BACKGROUND OF THE INVENTION

1. Field of the Invention

The present invention relates to accessing and registering communication service identifiers associated with people's various communication devices into a centralized directory.

2. Background

As people continue to increase the number of electronic communication services they use, there is an increasing need to ensure that the identifiers associated with these services are easy to manage, find, and update. The subject invention addresses this need with systems and processes that allow a person to organize, store and access communication identifiers through a centralized system, even though these identifiers are associated with different service providers.

A person typically uses several communication services, which have different IDs. These communication services include mobile phone service, E-mail service, short message service (SMS), facsimile service, Voice over Internet Protocol (VoIP), and instant messaging (IM). Thus, a single person is typically associated with multiple communication identifiers. Currently, a person must use a different ID for each service. For example, one uses a phone number to place a phone call, whereas one uses an email address when sending an email message. Furthermore, people typically have multiple identifiers for similar services. For example, a person typically has separate home, cellular, and work numbers, as well as various email addresses and IM screen names.

Managing all of these service identifiers is difficult. First, there is no centralized directory that can be used to look up all of another person's service identifiers. Second, a person periodically changes his/her identifiers. This typically happens when a person changes his/her service providers, home location, or job location. Furthermore, there is no easy way for persons to distribute their new contact identifiers when they change. Traditional directories do not allow users to either control or update their directory entries. As service providers introduce new communication services, people will have an even harder time managing their service identifiers.

Finding the various ways to reach a person typically requires a person to use various sources, because each service provider and/or directory only maintains a subset of a person's communication identifiers. Furthermore, these directories are often out of date. This makes it difficult for people to find all of another person's communication identifiers. For example, local telephone directories work well for finding home phone numbers for people located in a specific geographical area; however, these directories are inadequate for finding people's email addresses or IM screen names. Furthermore, there is no easy means for a person to update their contact information within these traditional directories.

Currently, personal directories are either difficult to create or are inconvenient to access. For example, it is possible for a person to use a personal website to distribute his/her contact information; however, this method requires a person to know how to build and maintain a website. Certain online websites and services, such as social networking sites and IM services, enable a user to share various personal information and communication service identifiers; however, these services require an Internet connection. Furthermore, these online services provide inadequate search methods and do not allow a user to set access levels.

Every time a person changes one or more of his/her communication IDs, that person has to inform all of his/her contacts. When broadcasting the change, that person may discover that the contact information for the people he/she is trying to notify is out of date. Furthermore, the person may wish to only notify a subset of his/her contacts when an ID changes. For example, the person may wish to only notify his/her friends and family when the person's home phone number changes, but notify all of the person's contacts when his/her work phone number changes.

There are ad hoc methods for specific services that enable a person to change a communication ID without broadcasting. For example, email forwarding services automatically forward emails from an old email address to a new email address; however, these forwarding services typically only work for a short time. Furthermore, not all types of communication offer a message forwarding service. The present invention circumvents this problem by introducing a Universal Directory Service (UDS).

Customizable, intelligent address books help people manage their service IDs on personal computers and mobile phones. Intelligent address books store incoming and outgoing communication service IDs into an electronic address book. The user can organize these IDs later. This system is useful for recording service IDs for people the user communicates with; however, these address books do not allow someone to search for service IDs.

U.S. Pat. No. 6,298,128 extends the traditional caller ID feature currently available on phones. The system enables a person to use an email address to look up and call a phone number or vice versa. However, this system is limited in scope.

U.S. Pat. No. 6,738,462 discloses a system that automatically generates a personal address that contains both phone numbers and email addresses. However, the system does not allow the user to search for communication IDs.

ENUM is a proposed system to add telephone numbers to the Domain Name Systems (DNS). The system would enable a user or software agent to find various contact information by using the subscriber's telephone number (i.e. their E.164 number). However, this proposed system is only a one-way look up. For example, you can go from a telephone number to an email address, but not the other way around.

Several proposed systems fall under the category of Unified Messaging. The goal of unified messaging is to provide people or content providers with a method for delivering a message to one or more of the intended recipient's devices. The basic idea is to make the message device independent.

U.S. Pat. No. 7,020,703 describes a system that routes messages through a centralized server. This server determines the appropriate means of message delivery. The server translates the message into the appropriate format(s), then, delivers the message to one or more of the recipient's devices. The sender is unaware of how the system delivers the message. The user is able to set preferences on how he/she wishes to receive messages.

The European Telecommunications Standards Institute (ETSI) has proposed a scheme to use a single permanent communication identifier, called the Universal Communication Identifier (UCI), for all of a person's communication services. In this system, the ETSI issues and manages everyone's UCI. The system uses a unified messaging server, called the Personal User Agent (PUA), to intelligently route messages. A UCI would be useful, because a person would only need to distribute a single ID to his/her contacts. Specifically, a person's email address would be the same as the person's mobile phone number. The system requires the PAU to coordinate all communication services. This is a severe limitation because it would be very hard to get competing service providers to cooperate. The ITU-T predicts that traditional telecommunication companies and Internet based communication services will increasingly compete with one another.

There have been attempts to mitigate the problems associated with a single user being associated with a multiplicity of communication IDs; however, there is no current method that allows a person to conveniently 1) register all of his/her communication IDs with a centralized universal directory and 2) access a centralized universal directory to find communication IDs of other people.

### SUMMARY OF THE INVENTION

In accordance with one aspect of the present invention, a Universal Directory Service (UDS) and set of associated processes enables a person or entity working on behalf of a person to easily distribute all of his/her various communication service identifiers (i.e., home phone number, email address, cell phone number, etc.) by simply distributing only one of the person's IDs. Thus the UDS allows a person or entity to easily find all of another person's communication service IDs, given that the first person or entity has at least one ID of the other person. The system is convenient because it allows users to access this centralized directory by using many common communication devices (i.e. computer, phone, PDA, etc.).

In accordance with another aspect of the present invention, a Universal Connection System (UCS) enables one person to connect to another person via any communication service by using one Universal ID (UID). The UCS enables one communication service to connect to a different communication service, even if different service providers operate these services.

In accordance with still another aspect of the present invention, a user-friendly process of “one call setup” enables a person to set up (i.e. register, create and configure) a remote address book (RAB) using a single phone call. The remote address book is a remote database and set of associated applications, which provides user a variety of contact management functions. A person may access his/her RAB by using a variety of communication services, such as phone, email, etc. The contact management applications enable a user to do the following: A user can auto-upload his/her contact information to the RAB from a personal device. A user can synchronize the remote address book with personal device's address book (i.e. a mobile phone's address book). A user can broadcast messages to other users or potential users in order to notify them that he/she has set up a RAB. Finally, a user can share contact information with other users and forward contact information to other users.

### BRIEF DESCRIPTION OF THE DRAWINGS

FIG. 1 is a flowchart of how an owner registers his/her service IDs with the Universal Directory System.

FIG. 2 is a flowchart of how a contact obtains a service ID of an owner.

FIG. 3 illustrates the process of how an owner creates different access levels.

FIG. 4 illustrates the process of how a contact retrieves private and public IDs.

FIG. 5 illustrates the process of placing a call using a UID via a two-way communication service.

FIG. 6 illustrates the general process of sending a message using a UID via a one-way communication service.

FIG. 7 illustrates the process of One-Call-Setup.

FIG. 8 is a block diagram of the Universal Directory Service implemented using a computer server.

FIG. 9 illustrates how an owner creates access groups in order control who has access to which IDs.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

### Universal Registering and Accessing Universal Directory Service

The term, owner or registrant, refers to a person or an entity operating on behalf of said person, who uses a set of communication IDs and is making them available in the universal directory.

The term, contact, refers to a person or an entity operating on behalf of said person, who is searching for one or more IDs in the universal directory.

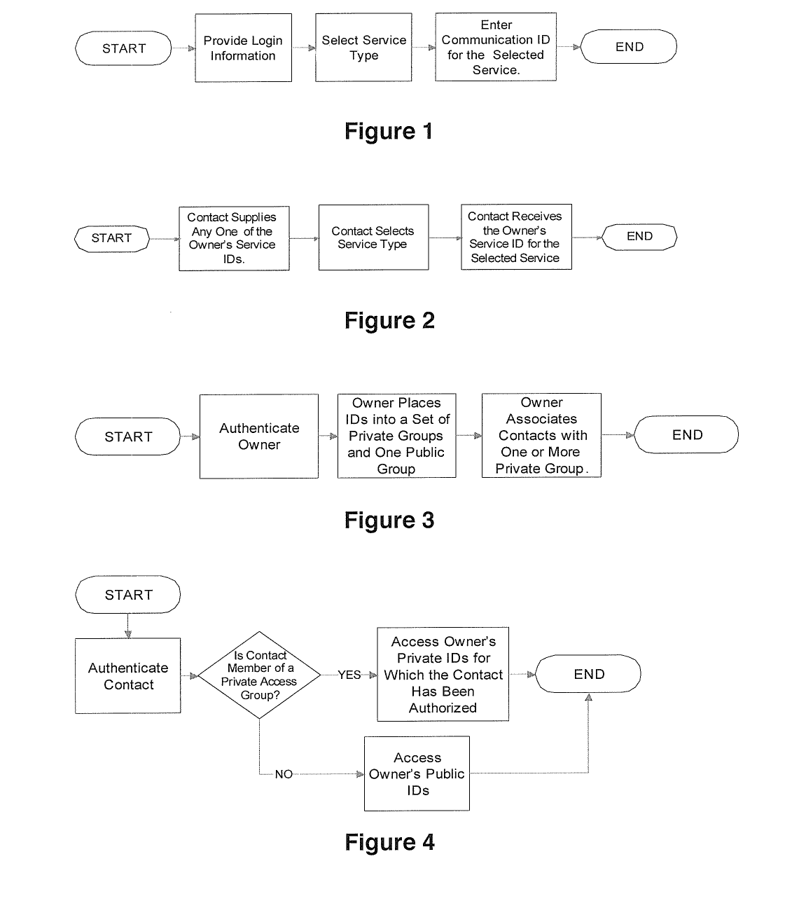

FIG. 1 illustrates the process of how an owner registers his/her service IDs with the Universal Directory Service. First, the owner logs in to the system. Next, the owner selects the type of communication service he/she wants to enter into the directory. Finally, the owner enters the corresponding communication ID.

FIG. 2 illustrates the process of how a contact gets the owner's service ID from the Universal Directory Server. First, the contact supplies any one of owner's service IDs. Next, the contact selects the type of service he/she desires. Note that this ID may be different from the ID the contact supplied in order to identify the owner. Finally, the contact receives the owner's ID from the server.

The process of universal registering and accessing has several advantages over previous systems. First, it enables a contact to acquire any of an owner's registered communication service IDs using a unified system. Second, the system associates all service IDs of one user to one another. Therefore, a contact only needs to know one of an owner's service IDs in order to access all of the owner's registered service IDs. Third, it allows an owner to control how his/her communication IDs accessed. The system is easy to use and enables the owner to maintain his/her privacy.

### Privileges/Access Levels

This section describes the processes associated with Access Levels. An owner controls how contacts access his/her service IDs by setting up access groups.

Access levels give an owner the ability to give different levels of access to different contacts or different groups of contacts. For example, access levels enable a user to give his/her family members unrestricted access to his/her communication IDs, while allowing business associates access only to office related communication IDs.

An owner creates access levels by placing his/her service IDs into a set of groups, then assigning contacts to each group. The owner may organize the groups in a flat or a hierarchical structure. There is one special group, call the Public Group. Everyone is able to access the IDs the owner places in this Public group.

FIG. 3 illustrates the process of how an owner creates different access levels. First, the system authenticates the owner's identity. Then, the owner organizes his/her service IDs into a set of groups such as Family, Friends, Work, and Public. Finally, the user associates his/her contacts with one or more groups.

FIG. 4 illustrates the process of how a contact retrieves private and public IDs. First, the system authenticates the contact's identity. If the contact is not a member of any private access group, the contact is restricted to accessing the owner's public IDs. If the contact is confirmed to be a member of a private access group, the contact is permitted to access the owner's private IDs for which the contact has been authorized by the owner.

There are several means to authenticate users, i.e. a means of identifying a user by the system and testing verifying that the user is who he/she claims to be. Authentication applies to both owners and contacts. In this document the term logs on is the same as authentication.

There are also several means to authorize a contact. A contact must be authorized in order to access IDs placed have been placed into one or more private groups. Below, I discuss the various processes of authentication and authorization.

### Owner Defined Password Authorization

In this process, the owner creates an alphanumeric password/pin for each group, except the public group. Thus, passwords are owner-controlled. The owner distributes the password/pin to the contacts he/she wishes to gain private access. The contact must supply a password every time he/she wants to access private service IDs.

### Owner Defined Security Question Authorization

In this method, the owner creates a security question and associated answer for each group except the public group. The question helps the contact remember the password. Furthermore, using a security question instead of a password enables people to gain private access depending on how well they know the owner. For example, the owner could use ‘What High School did I attend?’ as the security question in order to give former schoolmates with a certain level of private access. In order to access private data, a contact must answer a security question.

### Explicit Owner Authorization

In this method, the owner is in charge of explicitly assigning people to different groups based on authorization requests initiated by a contact. In this method, the owner has greater control over managing access to his/her private service IDs. The owner does not need to distribute passwords, which could potentially get into unintended hands.

As in previous authorization methods, one or more of the owner's communication IDs are marked as public, the rest of the owner's service IDs are placed into a set of private groups. Prior to authorization, a contact may only retrieve public service IDs.

There are two similar yet separate ways for a contact to gain private privileges as described below. The process involves both the owner and the contact.

Manual Process: The contact accesses one of the owner's public service IDs through one of the means described herein. Then the contact sends an access request using one of the owner's public service IDs. The access request contains a means of identifying the contact on the Universal Directory Service. Then the owner logs onto the system and places the contact into one or more private groups.

Automated Process: The contact logs onto the UDS and then sends an access request to the Universal Directory Server. The server processes the request and then sends the request, including some authenticated contact identifier, to the owner. The owner receives the request through a registered communication service. Then the owner logs onto the system and either grants the request or denies the request. The system notifies the contact of the owner's response through one of the contact's registered communications services.

### Authentication Methods

In this section, I discuss various Universal Directory Service authentication methods. There are two types of authentication: 1) User authentication is the process of identifying a user on the system and verifying the user's identity; 2) Service Authentication is the process of verifying that a particular service ID is being used by a particular user.

### Password User Authentication

In this standard method, users create passwords during the registration process.

Process: When the user creates a UDS account, he/she creates a login name and associated password. In order to log onto the system later, the user must enter both his/her user name and corresponding password.

### Individual Service Authentication

In this process, an owner verifies that he/she has access to a particular service associated with his/her given service identifiers.

Process: The owner logs onto the system and then selects a service ID. Then, the system sends a service password to that service ID. The owner receives the service password sent by the system. Then, the owner completes the service authentication by logging onto the system and entering the service password.

### Automatic User Authentication Using Registered Service ID

This section describes an automated user authentication process that uses authenticated service IDs; the user does not need to enter a password. In this process, the system automatically determines the service ID a user is using to access the system via a Caller ID system or similar method.

Process: First, the user authenticates a service ID, as described above. Later, when the user connects to the system using an authenticated service ID, the system automatically authenticates the user.

### Secure Delivery of a Private ID to a Authenticated Service ID

In this process, the user delays his/her authentication until the retrieval of the requested service IDs, rather than upon the initiation of service ID request. Thus, the contact may request a private service ID from an un-authenticated service (i.e. a pubic pay phone), then retrieve the requested private ID from an authenticated service (i.e. an email account).

Process: The contact uses any device to access the system. The contact makes a private service ID request for some owner. Then, the contact enters one or more authenticated service ID(s). Then, the user retrieves the requested private ID using the service associated with selected authenticated service ID.

### Automatic Community Authorization

In this process, the owner defines a set of authorization rules in order to allow a whole community access to a private group.

The owner defines a set of rules that will enable a verified user to gain access to specific set of service identifiers. For example, a user may authorize all people that have a registered email service with a *.lotusinterworks.com email address to gain private access (here * indicates a wildcard). This method reduces the need for the owner to authorize every contact that is associated with the specified wildcard.

Set-up Process: The owner logs onto system. Then, the owner selects a private access group. Then, the owner selects a service. Then, the owner enters a wildcard associated with the selected service. Then, the user selects one or more private access groups associated with the wildcard.

The above process allows contacts that have authenticated service IDs that match the owner-selected wildcard to access a set of private IDs.

### Updating Service IDs

An owner may update his/her service IDs with a relatively simple process.

Process: An owner uses one of the authentication methods to gain access to his/her UDS account. Then, the owner selects a service ID. Then, the owner provides a new or updated service ID.

### User Selected Universal Identifier (UID)

In this section, I describe the Universal Identifier (UID). A UID is a unique owner selected identifier. When an owner registers with the Universal Directory Service, the owner simply selects a Universal ID. A user is able to logon to the system using his/her UID. Similarly, a contact is able to request service IDs on the UDS using the owner's UID.

Most importantly, a first person is able to contact a second person using any type of communication service, as long as the first person knows the second person's UID. The first person does not need to know the individual service IDs for the second person. Below, I describe the various calling and messaging services used in conjunction with the Universal ID.

### Universal Connection Service (UCS) using Phone or Similar Service

In this section, I describe the processes associated with the Universal Connection Service (UCS) that enables a first user to connect to second user, using any service/device. In these processes, the first user only needs to know the Universal ID (UID) of the second user. The process enables a first person to place any type of call or send any type of message to the second person, even though different service providers control the various services used in the UCS. Here, the term call means initiating a connection with a two-way communication service, as in initiating a telephone connection or IM connection.

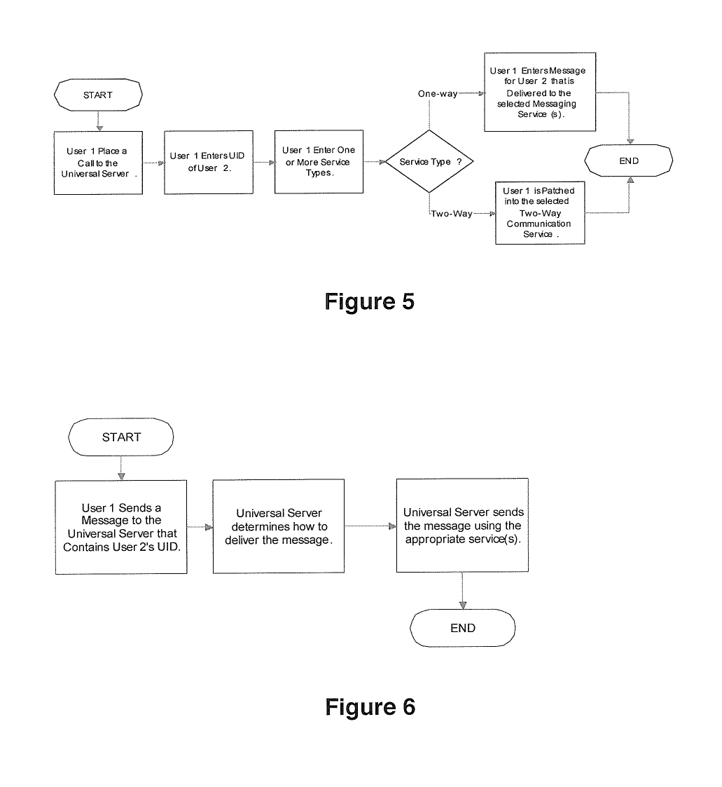

FIG. 5 illustrates the process of placing a call using a UID. User 1 places a call to the universal server. User 1 uses some means to enter the UID of user 2. Then user 1 enters one or more services types in order to either establish a connection with user 2 or send a message to user 2. The central server then either patches user 1 through to user 2, thus establishing a two-way communication service between user 1 and user 2, or allows user 1 to send a message to one or more of user 2's messaging services.

The following describes several extensions to the process illustrated in FIG. 5:
(1) The process includes some means of authenticating user 1, as described in previous sections.
(2) The process includes some means of providing user 1 with additional of delivery options if user 1 is not authorized to send user 2 a message by user 1's original service selection.
(3) The process includes some means of authorizing user 1 to connect to user 2 as described in previous sections.
(4) The process includes some means of converting speech-to-text or text-to-speech in order to enable user 1 to send user 2 a message.
(5) The process includes some means of providing user 1 with menu options in order to help user 1 select various options.

### Universal Connection Service using Email or Similar Service

In this section, I discuss the process of sending a message using a UID, such as, for example, sending an email using a UID.

FIG. 6 illustrates the general process of sending a message using a UID. User 1 sends a message to the universal server that contains User 2's UID. The universal server then processes the message in order to determine the proper means of delivery. Then the universal server sends the message using the appropriate service(s).

The following describes several extensions to the process illustrated in FIG. 6:
(1) The process includes some means of authenticating user 1, as previously described.
(2) The process includes some means of authorizing user 1 to send user 2 a message, as previously described.
(3) The process includes some means of providing user 1 with optional delivery methods if user 1 is not authorized to send user 2 a message through user 1's selected method.
(4) The process includes some means of providing text-to-speech and/or speech-to-text in order to convert the message into the appropriate format.

### Service Tags and Custom Tags

Tags are a set of UID modifiers that encode additional information. Tags help the UCS deliver a message or establish a 2-way communication channel. There are several types of tags.

A Universal Service Tag is a unique modifier that directs a message to the universal server in order to be processed. For example, the UID “Karsten” may use the universal service tag @universalserver.com to form Karsten@universalserver.com when using email.

A Service Tag encodes information that helps direct a UID message to a particular service. For example, a user may add the service tag-home to the UID karsten to form karsten-home, in order to direct a SMS message to Karsten's home phone voicemail.

Custom Tags encode user defined custom preferences such as the preferred service to return a message.

Tag Process: When sending a message or initiating a conversation, a user enters a UID and a tag. The universal server interprets the UID and tag. Then, the universal server takes the appropriate actions based on the given tag.

### One Call Setup

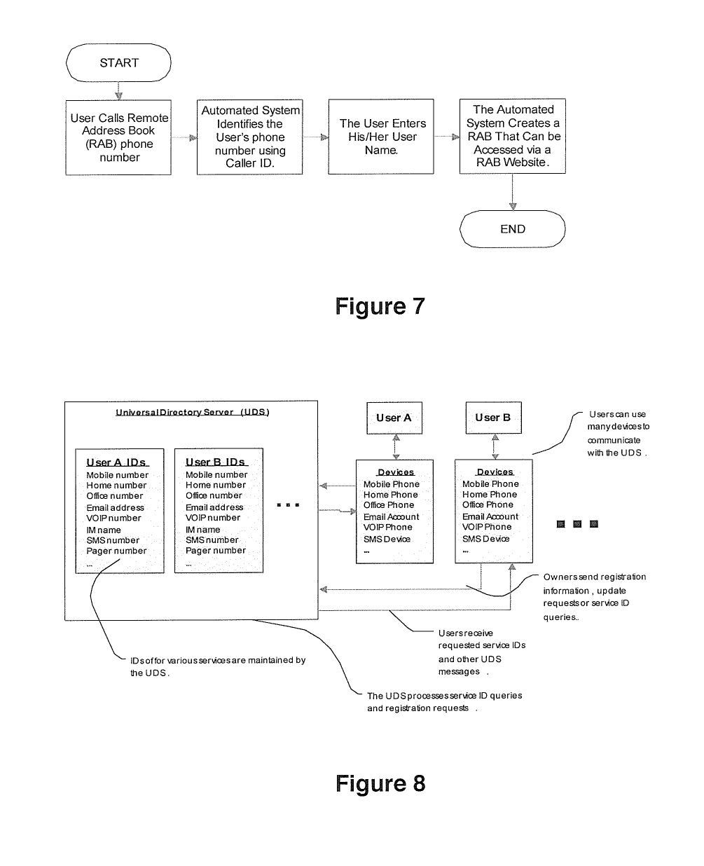

In this section, I introduce a user-friendly process called “One Call Setup”, which is illustrated in FIG. 7. The process enables a person to set up, (i.e. register, create and configure), a remote personal address book (RAB), using a single phone call. The remote address book consists of an address book database and set of associated address book applications. The applications give a user a variety of contact management functionality. A user may access his/her RAB using a variety of communication services, such as phone number or SMS. However, the most convenient method of accessing the RAB is through a website. Contact management features include, but are not limited to the following: A user may auto-upload his/her contact information from a particular device (i.e. mobile phone). The user can synchronize his/her RAB with other device. The user can broadcast messages to other users or potential users in order to notify them that he/she has set up an RAB. A user can share contact information stored in his/her RAB with other people's RAB. A user can forward a single entry in his/her address book to other users.

In the following sections, I discuss certain specific examples of my invention in practice.

### Universal Directory Service

FIG. 8 is a block diagram of the Universal Directory Service implemented using a computer server. The server is accessible by many different devices (any current or future device that provides a means of communication). For example, in one embodiment, a user may access the system by dialing a 1(800) number, sending an SMS message to the specific UDS number, accessing the universal directory server's website, such as www.universaldirectory.com, or sending an email message to the domain universalid.com.

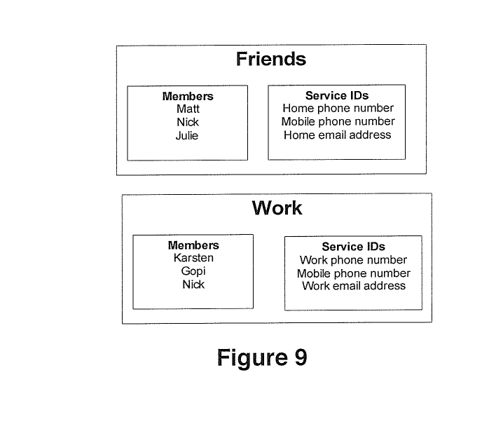

Users can register one or more of their communication service identifiers, which include, but are not limited to, their cell phone number, home phone number, email address, fax number, pager number, instant messenger name, and VoIP number. After an owner registers, contacts may query the system to find one or more of the owners' IDs. Additionally, the owner is able to create access groups in order control who has access to which IDs, as illustrated in FIG. 9.

### New Contact Scenario

Consider a situation wherein a registered owner meets an unfamiliar yet registered contact. The owner gives his/her cell phone number to the new contact. Later, when the contact wishes to send the owner an email, the contact calls a UDS 1(800) number using his/her home phone number in order to access the universal directory server. The UDS server immediately verifies the contact, because the contact has previously authenticated his/her home phone number. Specifically, the system recognizes the contact's home phone number by using a Caller ID system. The contact then enters the owner's cell phone number and requests the owner's email address.

If this owner's email is public, then the contact is able to select how he/she wishes to receive the contact information. The contact may choose to receive the information in an email or to get the address immediately over the phone.

If the contact's email address is private, the contact sends an access request to the owner. Using an automated access request process, the UDS sends the owner the access request by some specified preferred method. For example, the UDS may send the owner an SMS message. The owner then responds to this access request in order to grant the contact access by giving his/her private identifiers. The response message is processed by the UDS and sent to the contact. The user may now search for any of the contact's private IDs, including the originally requested email address.

### Existing Contact Scenario

Consider a scenario wherein a contact has been given full private access for a specific owner. The contact tries to call the owner's home phone number, but discovers that number is no longer in service. The contact has many ways to find the contact's new home phone number as long as the owner has updated his/her number with the UDS. For example, the contact can log onto the UDS website, enter his/her user name and password, then submit a home phone number request by first entering the owner's current email address, then requesting that his/her home phone number be displayed on the website. The UDS processes the request, checks the contact's access permissions, and immediately displays the owner's new home number.

### Non-Unique Service Identifiers

The UDS system needs to handle the case when the same service ID is associated with several people. For example, a family typically shares one home phone number. In this case, when the user enters this shared number, the system can either request more information in order to remove the ambiguity or give the user all of the service IDs associated with this shared home number.

### Universal ID Calling and Messaging

In this section, I describe how a person uses a Universal ID (UID) in order to place calls and send messages.

Email Example: Consider a scenario in which Karsten sends an email to Rosanne using her UID. The email includes two entries. Karsten sends the email to an address that contains the UID rosanne with the service tag-home, in order to direct the email to Rosanne's home email address. He also sends the email to an address that contains the UID rosanne with the service tag-sms, in order to direct the email to her SMS account. Both entries also use the universal server tag @universalid.com in order to direct the email to universal server in order to be processed.

Karsten sends an Email to Rosanne using the following header:

From: karstenc@universalid.com

To: rosanne-home@universalid.com (sends email to her home email address)

rosanne-sms@universalid.com (sends email to her phone via SMS)

Reply: reply line is karsten-sms or karsten-home

In this example, the universal server will recognize the UID karsten and thus know who is sending the email. It will verify his access level and either let the email go through to his intended targets (i.e. Rosanne's home email address and Rosanne's mobile phone as a SMS message) or it will take one of the following two actions if Karsten does not have access: either the system will route the message to a different public service, or it will just trash his email and give him the option of sending a private access request.

Instant Messaging (IM) Example: Consider a scenario in which Karsten sends an IM to Rosanne using her UID. Karsten sends an IM message to rosanne@universalid.com. The universal server processes the IM message and sends the message to either (1) all of Rosanne's active IM accounts, (2) to the IM system Rosanne has open, or (3) whatever IM account she has specified as her preferred IM account. This system works in much the same way as the currently available universal IM applications, except that it displays the universal IM buddy name in every IM client. For example, when Rosanne receives an IM from Karsten, she will see karsten@universalid.com in her buddy list. When Rosanne responds, the same process will happen in reverse. Rosanne's IM will first be sent to the universal sever, where it will be processed and then forwarded onto the IM client that Karsten is currently using. The universal server works as a proxy server.

Phone Call/Message Example: Consider a scenario in which Karsten using a phone to connect to Rosanne using her UID. Karsten places a call from his cell phone to 1-800-UNIVERS. The universal server recognizes Karsten, because he has previously registered his cell phone number with the universal server. The system prompts him to say or enter Rosanne's UID. The universal server recognizes the connection request from Karsten, looks up his access privileges, and gives him several options in an order predetermined by Rosanne. For example, Rosanne may have instructed the system to display her cell phone number first, because it is the easiest way to reach her. The system gives Karsten a menu of Cell Phone, IM, Email, Home Phone, Office Phone or VoIP. Karsten chooses one or more services from the menu. The system either patches him through or allows him to say a message into a voice translator, which performs a speech-to-text conversion. Then the system sends his message to the service(s) selected by Karsten (i.e. Email, IM, and/or SMS). If Karsten decides to send the message via email, then the system will send the message to Rosanne's email account. Rosanne will know that the message origin was Karsten's cell phone, because the sender's address would be karsten-cell@universalid.com. Upon retrieving the email message, Rosanne could either call Karsten on his cell phone or simply reply to the email.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A universal directory service comprising a database of communication identifiers for a plurality of owners, each owner having at least one communication identifier for each of a plurality of communication services, the database accessible to a contact of an owner to retrieve a communication identifier for the owner for a communication service specified by the contact.

2. The universal directory service of claim 1 wherein the owner controls how the contact obtains access to the owner's communication identifier.

3. The universal directory service of claim 2 wherein the owner establishes different access levels for the owner's contacts.

4. The universal directory service of claim 2 wherein an owner-defined password is required to retrieve a communication identifier for the owner.

5. The universal directory service of claim 4 wherein the owner defines a unique password for each of a plurality of access groups.

6. The universal directory service of claim 2 wherein the contact is required to answer an owner-defined security question to retrieve a communication identifier for the owner.

7. The universal directory service of claim 6 wherein the owner defines a unique security question for each of a plurality of access groups.

8. The universal directory service of claim 2 wherein the owner explicitly assigns a contact to one of a plurality of access groups.

9. The universal directory service of claim 8 wherein the owner assigns the contact to one of the plurality of access groups in response to a request received directly from the contact.

10. The universal directory service of claim 8 wherein the owner assigns the contact to one of the plurality of access groups in response to a request submitted to the universal directory service by the contact.

11. The universal directory service of claim 1 further comprising an owner-defined password required for owner access to the database.

12. The universal directory service of claim 1 further comprising communication service authentication of the owner for at least some of the plurality of communication services.

13. The universal directory service of claim 12 wherein the communication service authentication requires an owner-defined password.

14. The universal directory service of claim 12 wherein the communication service authentication is performed automatically by identification of the owner upon access to the communication service.

15. The universal directory service of claim 1 wherein the contact is provided the communication identifier for the owner via secure delivery on an authenticated communication service.

16. The universal directory service of claim 15 wherein the contact submits the contact's communication identifier for the authenticated communication service to the universal directory service.

17. The universal directory service of claim 1 wherein all contacts belonging to an owner-defined group to retrieve at least one of the owner's communication identifiers.

18. The universal directory service of claim 1 wherein the owner accesses the database to update the owner's communication identifiers.

19. The universal directory service of claim 1 further comprising the owner defining a unique universal identifier.

20. The universal directory service of claim 19 wherein a contact having the owner's universal identifier may retrieve all of the owner's communication identifiers.

21. The universal directory service of claim 19 wherein communications between the contact and the owner are automatically established on a contact-specified communication service in response to the contact providing the owner's universal identifier.

22. The universal directory service of claim 21 further comprising authentication of the contact.

23. The universal directory service of claim 21 further comprising the contact selecting an alternate communication service if service on the contact-specified communication service is denied.

24. The universal directory service of claim 21 further comprising authorization of the contact's request to communicate with the user.

25. The universal directory service of claim 21 further comprising a conversion of a contact's speech message to text for delivery to the owner on the contact-specified communication service.

26. The universal directory service of claim 21 further comprising a conversion of a contact's text message to speech for delivery to the owner on the contact-specified communication service.

27. The universal directory service of claim 21 further comprising providing the contact with menu options to assist with establishing communications with the owner.

28. The universal directory service of claim 19 further comprising a modifier tag combined with the owner-defined universal identifier.

29. The universal directory service of claim 28 wherein the modifier tag specifies a communication address.

30. The universal directory service of claim 28 wherein the modifier tag specifies a communication service.

31. The universal directory service of claim 28 wherein the modifier tag specifies a communication option.

32. The universal directory service of claim 1 wherein the database further comprises an owner's personal remote address book.

33. The universal directory service of claim 32 wherein communication identifiers in the database are obtained from the owner's personal remote address book

34. A method comprising:
a communication directory registrant registering communication identifiers at a communication directory center;
assigning each of the registrant's communication identifiers to one or more groups;
assigning a registrant's contact to one or more of the groups;
the registrant's contact contacting the communication directory center;
providing the registrant's contact with at least one of the registrant's communication identifiers in groups to which the registrant's contact is assigned.

35. The method of claim 34 wherein the registrant's communication identifiers include at least one of a home phone number, mobile telephone number, facsimile number, short message service identifier, instant messaging identifier or email address.

36. The method of claim 34 further comprising requiring the registrant's contact to provide at least one of the registrant's communication identifiers to the communication directory center prior to being provided with another of the registrant's communication identifiers in groups to which the registrant's contact is assigned.

37. The method of claim 34 wherein the registrant's communication identifiers include identifiers for at least two different service providers.

38. The method of claim 34 wherein the registrant's contact is provided with all of the registrant's communication identifiers in groups to which the registrant's contact is assigned.

39. The method of claim 34 further comprising the registrant's contact requesting a communication identifier for a specified type of service.

40. The method of claim 34 further comprising authenticating the registrant's contact before providing the registrant's contact with a communication identifier of the registrant.

41. The method of claim 40 wherein authenticating the registrant's contact comprises requiring the registrant's contact to furnish a password.

42. The method of claim 40 wherein authenticating the registrant's contact comprises requiring the registrant's contact to answer a security question.

43. A method comprising:
a communication directory registrant registering a plurality of communication identifiers at a communication directory center;
a registrant's contact contacting the communication directory center;
authenticating the registrant's contact;
providing the registrant's contact with at least one of the registrant's communication identifiers.

44. The method of claim 43 wherein authenticating the registrant's contact comprises requiring the registrant's contact to furnish a password.

45. The method of claim 43 wherein authenticating the registrant's contact comprises requiring the registrant's contact to answer a security question.

46. The method of claim 43 wherein the registrant's communication identifiers include at least one of a home phone number, mobile telephone number, facsimile number, short message service identifier, instant messaging identifier or email address.

47. The method of claim 43 wherein the registrant's communication identifiers include identifiers for at least two different service providers.

48. The method of claim 43 further comprising the registrant's contact requesting a communication identifier for a specified type of service.

49. A method of communicating comprising:
a contacting party accessing a universal directory service having a database of communication identifiers for a plurality of owners;
the contacting party supplying identifying information for one of the owners;
establishing communication between the contacting party and said one of the owners.

50. The method of claim 49 wherein communication between the contacting party and said one of the owners is established via telephone.

51. The method of claim 49 wherein communication between the contacting party and said one of the owners is established via email.

52. The method of claim 49 wherein communication between the contacting party and said one of the owners is established via facsimile.

53. The method of claim 49 wherein communication between the contacting party and said one of the owners is established via instant messaging.

54. The method of claim 49 wherein communication between the contacting party and said one of the owners is established via short message service.

55. The method of claim 49 wherein communication between the contacting party and said one of the owners is established via a communication service specified by the contacting party.

56. The method of claim 49 wherein communication between the contacting party and said one of the owners is established via a communication service specified by said one of the owners.
